(19) United States
(12) Patent Application Publication
(10) Pub. No.: US 2011/0108069 A1
(43) Pub. Date: May 12, 2011

(54) METHOD AND COMPOSITION FOR REMOVING CONTAMINATION FROM SURFACES IN CONTACT WITH WATER

(75) Inventors: Wolfgang Friedrich Zwanziger, Oklahoma City, OK (US); Ulrich Reimann-Philipp, Norman, OK (US)

(73) Assignee: FLORAN TECHNOLOGIES, INC., Oklahoma City, OK (US)

(21) Appl. No.: 12/742,576

(22) PCT Filed: Nov. 13, 2008
(86) PCT No.: PCT/US08/83366

§ 371 Date: May 12, 2010

Related U.S. Application Data
(60) Provisional application No. 60/987,624, filed on Nov. 13, 2007.

(30) Foreign Application Priority Data
Nov. 13, 2007 (US) 60987624

(51) Int. Cl. B08B 3/00; A01N 59/00; A01N 37/16; A01P 1/00; A01P 13/00; A01P 9/00

(52) U.S. Cl. 134/26; 424/616; 514/546

(57) ABSTRACT

A composition and method for the removal of biological fouling from wetted surfaces intermittently or continuously in contact with water is disclosed. The method includes the steps of preparing a cleaning composition of basic pH from a strong base and an active oxygen donor component, applying the composition to the surface to be cleaned, and after a selected residence time, removing any unreacted cleaning composition and all removed fouling by rinsing or flushing with water.

### FIELD OF THE INVENTION

The present invention is generally directed toward surface cleaning processes. More specifically, the present invention is directed toward a process for removing organisms and contaminants, which become attached to periodically or permanently wetted surfaces.

### BACKGROUND OF THE INVENTION

The surface of any structure, body, conduit, container or medium exposed to water, for example rain, surface water, drinking water, pool water, industrial process water or cooling water, or even high humidity, either permanently or intermittently, will over time accumulate deposits of biological and non-biological material. These deposits originate from the water and settle on the exposes surfaces. The deposits often can only be removed with harsh chemicals, which are detrimental to the environment. In extreme cases, the deposits may even require removal by mechanical means. Depending on the water source and environmental conditions, these surface deposits may include in addition to organic matter (biofilm) also metal oxides, or calcium carbonate scale, or suspended solids.

Heavy fouling of the surface can lead to unaesthetic discoloration or even damage to the contaminated surface, for example corrosion. One example of colonization of a surface with biological material is the formation of zebra mussel colonies in on structures exposed to surface water. Sponges, Hydroids and Bryozoa also grow on surface water exposed surfaces. Algae and lichens can grow on any surface exposed to light and water and can contribute to not only surface discoloration, but also surface damage.

Current methods for removing biological growth from surfaces can be grouped into mechanical and chemical methods. Mechanical methods include high-pressure washing, scraping and flushing and combinations thereof. Chemical surface treatments include the use of acids, bases and chlorine, alone or in combination with surfactants and detergents. These chemical treatments can be satisfactory for certain types of contamination, such as calcium carbonate scale. However, mixed deposits, which include metal oxides and biological films, are either not removed efficiently or require highly corrosive and hazardous cleaning agents which are difficult to use and may leave environmentally unacceptable residue. Biological deposits can also be controlled by adding biocides to the water itself or by preventive measures such as applying anti-fouling surface coatings or erecting barriers against the attachment of organisms.

All these methods have shortcomings. Mechanical methods are limited by accessibility to the affected surfaces, potentially destructive effects of treatment and high labor and downtime cost. Chemical methods such as anti-fouling agents and biocidal water additives cannot be widely used due to environmental concerns. Thus, a need exists for a method which offers efficient deposit removal together with safety and ease of application and applicability in environmentally sensitive situations.

### SUMMARY OF THE INVENTION

It is an object of the invention to provide an economical and effective means of removing biological surface deposits from wetted surfaces.

The term “wetted surface” as used herein defines any surface, which is permanently or periodically in contact with water. The term water as used herein includes rainwater, surface water, wastewater, industrial process water, industrial wastewater, well water, spring water and processed drinking water.

The invention provides a method and composition for chemically removing biological fouling from wetted surfaces. The term ‘biological fouling’ as used herein includes bacterial films, algal lawns and colonies of organisms such as mussels, sponges or other sessile invertebrate animals. Examples are zebra mussels, sponges, hydroids and bryozoa.

In a preferred embodiment, the invention further provides a method and compositions for chemically removing both biological fouling as well as other surface contaminations, such as dirt, scale, metal oxide deposits, etc.

The methods and compositions of the invention are universally usable and can be applied for the cleaning of a wide variety of exterior or industrial structures, buildings and installations. For example, the invention can be used for the cleaning of buildings, homes, highways, bridges, roadside walls, overpasses, building exteriors, cooling towers, heat exchangers and scrubbing towers inside and outside to clean “grime” or organic growth from surfaces exposed to water or high humidity. Other applications are for the cleaning of building piping, such as plumbing in hi-rise buildings, water, brewery, distillery and wine piping systems, or drinking water systems for ships, boats, airplanes, recreational vehicles, ice making machines, etc. The invention also finds application in structures and processing equipment of pulp and paper mills, grain and cane processing plants, brewery, distillery and wine making installations, ships and boats (outside hulls and cargo holds), trains and trucks (outside and cargo holds), industrial wastewater purification applications (such as silicon chip manufacture) and treatment or industrial process membrane filter elements. Additional applications are grime (mold) removal in households, especially high humidity areas such as bathrooms and basements, for example for the cleaning of walls, floors, bathtubs and sinks. Due to its broad applicability, the invention can also be used for the cleaning of food handling and processing machinery and buildings (room surfaces etc), food selling surfaces (such as shelving at a deli), hospitals and medical facilities (all surfaces). Other applications are refinery applications (towers, plumbing, tanks), pipelines (irrespective of what they transport), wells (oil, gas, water) and residential or industrial wastewater gathering, treatment and distribution systems.

The preferred method in accordance with the invention includes the steps of preparing a cleaning composition by mixing two separate components immediately before application and subsequently exposing the surface with biological fouling to the cleaning solution, preferably by spraying the cleaning composition onto the affected surfaces or by soaking the affected surfaces in the cleaning composition. The method preferably includes the further step of removing dislodged biological fouling together with residual cleaning chemicals through rinsing with water. The rinse water is preferably applied by flushing, spraying, or pressure-washing.

The preferred cleaning composition in accordance with the invention is a basic cleaning composition, which includes at least two components, a basic component, preferably in the form of a solution of basic pH, and an active oxygen donor. The basic solution preferably contains potassium hydroxide or sodium hydroxide or a blend thereof.

For the purpose of this disclosure, the term active oxygen donor defines compounds, which in aqueous solution decompose to generate oxygen radicals. Numerous active oxygen donors of this type are known and need not be listed in detail. The active oxygen donor is preferably selected from peroxides, most preferably hydrogen peroxide, peracetic acid, precursors of peroxides, hydrogen peroxide and peracetic acid and combinations thereof. The activator is most preferably either 0.1-20% hydrogen peroxide, or 0.1-10% peracetic acid, or a combination of hydrogen peroxide and peracetic acid, with the balance being water.

Additional optional ingredients, which can be included in the cleaning composition include defoaming agents, corrosion inhibitors and dyes. Surfactants facilitate the dispersal of the cleaning solution and support the dislodging of attached organisms. Defoaming agents are added to prevent spills and facilitate the rinsing step.

The components of the cleaning composition in accordance with the invention are preferably concentrated stock solutions or readily prepared solutions. Preferably, the cleaning solution is prepared by diluting concentrated stock solutions of the components to a desired final concentration in a mixing container at the site of application. The optional ingredients of the cleaning composition are preferably included in the basic component to avoid decomposition by oxygen radicals.

In a preferred embodiment of the basic cleaning composition, the basic component, active oxygen donor component and optional ingredients are selected as follows:

| | |
|---|---|
| KOH | 0.1-11M |
| NaOH | 0.1-10M |
| Surfactant | 0-2% (w/w) |
| Anti-foaming agent | 0-2% (w/w) |
| H202 | 0.1-20% (w/w)* |
| Peracetic acid | 0-5% (w/w) |

*At Na)H concentrations ≧5M, the H202 concentration must be reduced to ≦1%.

In another preferred embodiment, the cleaning process of the invention is a combination treatment process, which includes the additional step of applying an acidic cleaning composition to the treatment surface for removal of mineral deposits on the treatment surface before or after the rinsing step. The acidic cleaning composition preferably includes at least two components, an acidic component and an active oxygen donor. Additional optional ingredients include surfactants, corrosion inhibitors, defoaming agents and dyes.

In still another preferred embodiment of the process of the present invention, the amounts of basic and acidic cleaning composition are selected such that the cleaning residue accumulated after application of both compositions and prior to the rinsing steps is substantially pH neutral.

In a preferred embodiment of the acidic cleaning solution, the acidic component is sulfamic acid. In another preferred embodiment, the acidic component includes at least one additional ingredient selected from the group of citric acid, phosphoric acid, glycolic acid, hydrochloric acid, corrosion inhibitor, free-flow additive and surfactant. Preferably the acidic cleaning composition includes the following components:

| Component | Volume (w/w) |
|---|---|
| Sulfamic acid; | 50-99% |
| citric acid; | 0-10% |
| phosphoric acid; | 0-10% |
| corrosion inhibitor; | 0-10% |
| Free-flow additive; | 0-10% |
| surfactant; and | 0-10% |
| Sodium bicarbonate | Balance |

The acidic cleaning composition can be in liquid form, such as the cleaning compositions disclosed in EP 1 196 033 incorporated herein in its entirety by reference, or in granular form such as the cleaning compositions disclosed in WO2006/021861, filed Aug. 22, 2005, incorporated herein in its entirety by reference.

In an especially preferred embodiment of the combination treatment process, the basic cleaning composition and the acidic cleaning composition are applied successively to a contaminated surface to achieve a thorough removal of all surface contaminants. It is an especially advantageous feature of this combination treatment process that the amounts of basic and acidic cleaning composition can be adjusted to achieve a runoff of substantially neutral pH. Due to this neutral pH and the biodegradability of the ingredients used in both compositions, the resulting cleaning runoff is biodegradable and not harmful to the environment.

In another especially practical embodiment of the invention, the acidic cleaning composition of the invention is used in combination with a protecting composition for the protection of surfaces, which are adjacent to or in contact with the surface to be cleaned and are susceptible to damage by the cleaning composition. In this embodiment, the protective composition is applied to the susceptible surface before or during application of the cleaning composition. In a particularly preferred variant of this composition, the cleaning composition is one of the basic or acidic cleaning composition and the protective composition is the other cleaning composition. Although the protective composition is advantageously also a cleaning composition in order to avoid attachment to the susceptible surface of the contaminants removed from the surface being cleaned, simple protecting compositions without intended cleaning activity can also be used.

The principle is to create a protective barrier between a susceptible surface and the potentially damaging cleaning composition. This protective barrier is achieved with the use of the protecting composition, which can potentially provide a chemical and/or physical barrier between the cleaning composition and the susceptible surface. The protective composition can be applied by spraying, brushing or rolling it directly onto the susceptible surface, or could be injected next to the susceptible surface in applications in which the susceptible surface is submerged. The protecting composition can be, for example, a metal hydroxide, such as sodium hydroxide, or potassium hydroxide, a common base, or a basic cleaning composition. To improve adhesion and residence time of the protecting composition, it can be admixed with viscosity altering components to help control premature release of the protecting composition from the susceptible surface. For the same purpose, the protecting composition can be in the form of an emulsified oil composition, or even a water-soluble wax composition. In a particularly simple and effective embodiment, the protective composition itself is an emulsified oil or water soluble wax composition. The protective composition preferably includes a dye to assist with and facilitate application and visible detection.

### BRIEF DESCRIPTION OF THE DRAWINGS

Preferred embodiments of the invention will now be further described by way of example only and with reference to the attached drawings, wherein

FIG. 1 is a schematic flow diagram of a preferred process in accordance with the present invention;

FIG. 2 is a schematic flow diagram of a combination treatment method in accordance with the invention; and

FIG. 3 is a schematic flow diagram of a variant of the process of FIG. 1 or 2.

FIG. 4 is a schematic flow diagram of a variant of the process of FIG. 3.

### DETAILED DESCRIPTION

Before explaining the present invention in detail, it is to be understood that the invention is not limited to the preferred embodiments contained therein. The invention is capable of other embodiments and of being practiced or carried out in a variety of ways. It is to be understood that the phraseology and terminology employed herein are for the purpose of description and not of limitation.

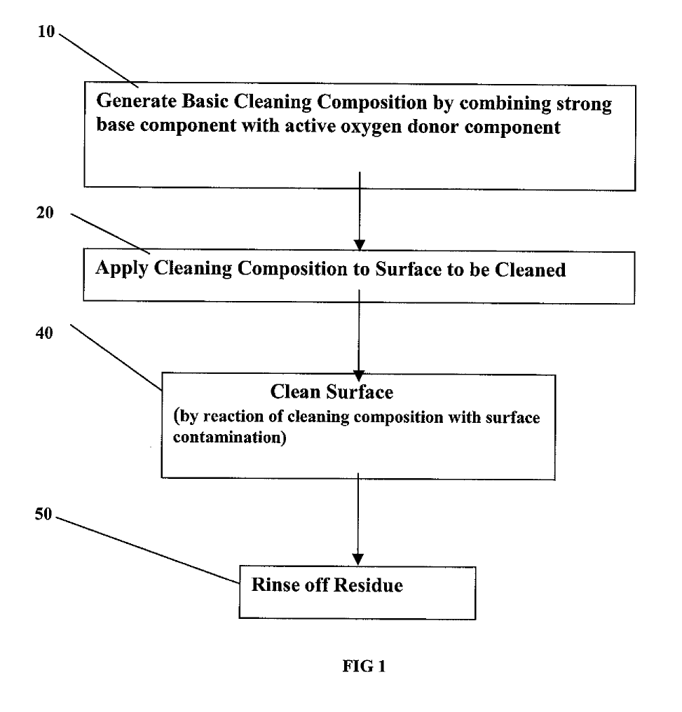

FIG. 1 is a schematic flow diagram of a preferred embodiment of a process in accordance with the invention for the cleaning of wetted surfaces, for example any facilities and equipment used in the treatment and distribution of water, such as water conduits or water filtration media contained within a filtration bed, boat hulls, swimming pools, cooling towers, heat exchange media, etc. In this embodiment, the process includes a first, cleaning composition generation step 10, wherein a solution of a strong base component is mixed with an active oxygen donor component, and a second, cleaning composition application step 20, in which the resulting cleaning composition is applied to the wetted surface. In a reaction step 40, the base component chemically reacts in conjunction with the active oxygen donor component and the biological fouling on the wetted surface, resulting in the cleaning of the surface. The duration of reaction step 40 varies depending on the degree of contamination. However, the reaction step 40 is preferably carried out for at least 30 minutes, preferably one hour, most preferably the reaction step is conducted over night. Most preferably, the reaction step 40 is carried out until the wetted surface is completely cleaned. The point in time at which the surface is completely cleaned can be determined by visual inspection to check for any foaming which would indicate an ongoing cleaning reaction and/or by measuring the supernatant pH.

The inventors of the present process surprisingly discovered that the use of a strong base in combination with an active oxygen donor significantly improved cleaning efficiency and biological deposit removal over existing treatment methods, without the need for additional chemical or mechanical cleaning. This provides the process of the current invention with significant economical and practical advantages.

After the cleaning step 40, any residual cleaning composition is washed away along with the suspended and dissolved deposits which were removed from the wetted surface by rinsing with water in a rinsing step 50. The rinsing step can be carried out by spraying water onto the surface media or by flushing. The rinsing step 50 is best carried out until all residual cleaning composition and all dissolved and suspended bio-contaminants have been removed. Completion of the rinsing step 50 can be determined by monitoring the turbidity and, pH of the rinsate water, for example. Disposal of the rinsate can be carried out in various ways, depending on local regulations.

Prior to the application step 20, system facilities, conduits, storage containers, or the like which are submerged are preferably drained to expose the wetted surfaces to be cleaned. In the alternative, the cleaning composition is applied to the water present in either liquid or granular form and in a sufficient amount and concentration to achieve a reaction in the reaction step 40.

The cleaning composition of a preferred embodiment of the invention includes the strong base component, the active oxygen donor component and at least one additional component selected from the group of a surfactant for reducing surface tension and enhancing contact of the cleaning composition with the surface to be cleaned, and a coloring agent.

The strong base component of the preferred cleaning composition is preferably a metal hydroxide, such as potassium hydroxide or sodium hydroxide, or combinations thereof.

Surfactants useful for inclusion in the cleaning composition in accordance with the invention can be selected from the group of anionic, cationic, nonionic and amphoteric surfactants. Useful anionic surfactants include, by way of non-limiting example, alkaline metal salts, ammonium salts, amine salts, aminoalcohol salts, fatty acid salts. Particularly preferred surfactants are Thomadol 91-6 and Thomalkali surfactant (both available from Thoma Products, Inc.). For use in drinking water processing installations, surfactants are preferred which are NSF certifiable.

Defoaming agents useful for inclusion in the cleaning composition in accordance with the invention can be selected from the group of silicone, non-silicone or emulsified oil defoaming agents. The most preferred defoaming agent is DSP antifoam emulsion (commercially available from Dow Corning).

The active oxygen donor component used in the cleaning composition in accordance with the invention is preferably selected from hydrogen peroxide, peracetic acid, precursors of hydrogen peroxide and peracetic acid and combinations thereof. Examples of granular precursors of activated oxygen donors applicable for use in the preparation of the cleaning composition in accordance with the invention are sodium percarbonate and BSC 8080, available from Buckman Laboratories. The active oxygen donor component is preferably either 0.1 to 20% hydrogen peroxide or 0 to 5% peracetic acid with the balance being water. The oxygen donor component can be in a liquid or dry state prior to its inclusion into the cleaning composition in the cleaning composition generation step 10.

The cleaning composition in accordance with the invention preferably includes the following components at the indicated amounts:

| | |
|---|---|
| KOH | 0.1-11M |
| NaOH | 0.1-10M |
| Surfactant | 0-2% (w/w) |
| Anti-foaming agent | 0-2% (w/w) |
| H202 | 0.1-20% (w/w)* |
| Peracetic acid | 0-5% (w/w) |

*At NaOH concentrations ≧5M, the H202 concentration must be reduced to ≦1%.

As will be readily understood from the indicated volume ranges, all compounds having a volume range with a lower value of 0 or optional components.

Exemplary formulations illustrating preferred embodiments of the above general cleaning composition are described in detail in the following:

### Example 1

| | |
|---|---|
| NaOH | 0.1-10M |
| Surfactant | 0-2% (w/w) |
| Anti foaming agent | 0-2% (w/w) |
| H2O2 | 0.1-10% (w/w)* |
| Peracetic acid | 0-5% (w/w) |

*At NaOH concentrations of ≧5M the H2O2 concentrations have to be reduced to ≦1%.

### Example 2

| | |
|---|---|
| KOH | 0.1-11M |
| Surfactant | 0-2% (w/w) |
| Anti foaming agent | 0-2% (w/w) |
| H2O2 | 0.1-20% (w/w)* |
| Peracetic acid | 0-5% (w/w) |

### Example 3

| | |
|---|---|
| NaOH/KOH combined | 0.1-10M |
| Surfactant | 0-2 % (w/w) |
| Anti foaming agent | 0-2 % (w/w) |
| H2O2 | 0.1-10 % (w/w)* |
| Peracetic acid | 0-5 % (w/w) |

*At NaOH concentrations of ≧5M the H2O2 concentrations have to be reduced to ≦1%.

The individual constituents of the cleaning compositions described herein are commercially available from various sources including those described in McCutcheon's Functional Materials (Vol. 2), North American Edition, 1991; and in Kirk-Othmer, Encyclopedia of Chemical Technology, 3^{rd} Edition, Vol. 22, the contents of which are incorporated herein by reference. For any particular cleaning composition, the optional components used should be compatible with all other ingredients included in the composition.

In the application step 20, the cleaning composition in accordance with the invention is applied to the surface to be cleaned by soaking the surface in the cleaning solution for at least 30 minutes, or by spraying the cleaning solution onto the surface, preferably by low pressure spraying. The rinsing step 50 can be carried out by spraying, high pressure washing, flushing or backwashing, especially when cleaning filters containing granular or membrane filtration media.

When the cleaning composition in accordance with the invention is used for the cleaning of a water line, the cleaning composition is applied by soaking the water line for at least 30 minutes and removing any residual unreacted cleaning composition and the dislodged surface deposits by flushing of the treated waterline with water. For the cleaning of filter media, the cleaning composition is preferably sprayed onto the top of the filter bed after the bed has been drained and all residual unreacted cleaning composition as well as the dislodged surface deposits are removed by backwashing the filter.

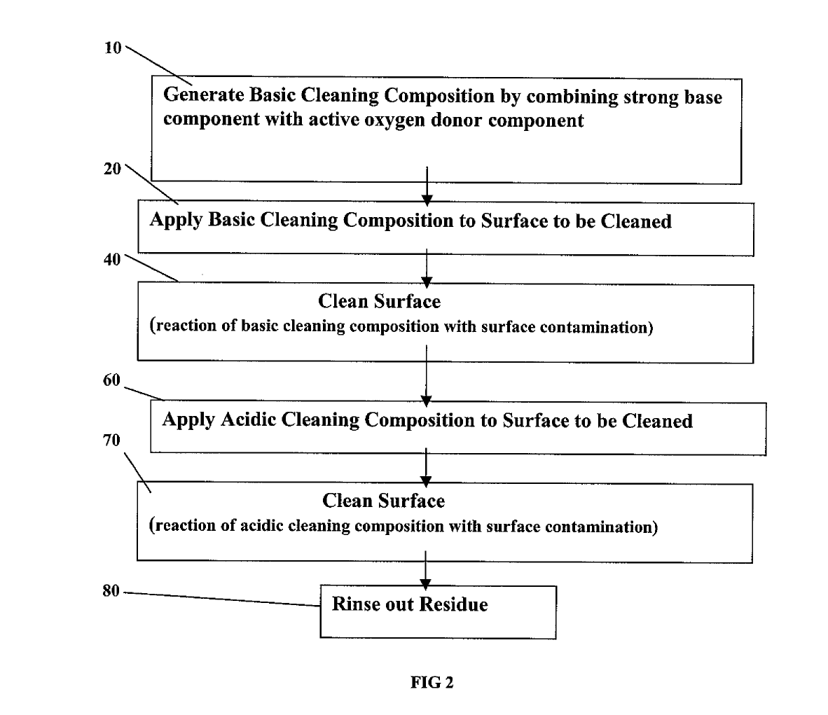

The basic cleaning composition of the present invention can also be used in a combination treatment process as illustrated schematically in FIG. 2, in which the basic cleaning composition is used in combination with an acidic cleaning composition to achieve removal of biological fouling as well as mineral deposits. The combination treatment process includes the basic cleaning composition generation step 10, the basic cleaning composition application step 20 and the reaction step 40 as described above in relation to FIG. 1. The combination process further includes the additional steps of a second application step 60 in which an acidic cleaning composition is applied to the treatment surface for removal of mineral deposits on the treatment surface, and a second reaction step 70 in which the acidic cleaning composition is maintained in contact with the surface to be cleaned. The combination process also includes a rinsing step 80 in which any unreacted cleaning composition and any removed deposits and fouling are washed away by rinsing with water. The rinsing step 80 can be carried out in a similar manner to the rinsing step 50 discussed above by spraying water onto the treated surface or by flushing. Although the combination process in accordance with the invention preferably includes both the rinsing step 50 and the second rinsing step 80, the rinsing step 50 can be omitted. The second rinsing step 80 is best carried out until all residual cleaning composition and all dissolved deposits and suspended bio-contaminants have been removed. Completion of the second rinsing step 80 can be determined as in the rinsing step 50 by monitoring the turbidity and, pH of the rinsate water, for example. If both rinsing steps are carried out, the rinsate from the second rinsing step 80 is preferably combined with the rinsate from rinsing step 50. In particular, both rinsates are preferably captured and combined in the same container, such as a lagoon, for at least a partial pH neutralization. Preferably, rinsing step 50 is carried out before application of the acidic cleaning composition. If the rinsing step 50 is omitted, all residual cleaning composition, both basic and acidic, is removed together with all dissolved scaling and removed fouling and washed away in the second rinsing step 80. This renders the process more economical. It will be readily understood by the person skilled in the art that the basic and acidic cleaning composition can be applied in any sequence. Multiple, alternating applications of the basic and acidic cleaning compositions can also be carried out with rinsing after cleaning completion or intermittently during the process. It is also easily understood that although the basic cleaning composition is preferably applied prior to the acidic composition, to remove any biological fouling which may cover up underlying scaling, the sequence of application can also be reversed.

The acidic cleaning composition preferably includes at least two components, an acidic component and an active oxygen donor. Additional optional ingredients include surfactants, corrosion inhibitors, defoaming agents and dyes. Preferred acidic cleaning compositions for use in the present combination process are disclosed in EP 1 196 033.

The preferred granular acidic component is sulfamic acid, at least one additional ingredient selected from the group of citric acid, phosphoric acid, corrosion inhibitor, free-flow additive and surfactant. Preferably the acidic cleaning composition includes the following components:

| Component | Volume (w/w) |
|---|---|
| sulfamic acid; | 50-99% |
| citric acid; | 0-10% |
| phosphoric acid; | 0-10% |
| corrosion inhibitor; | 0-10% |
| Free-flow additive; | 0-10% |
| surfactant; and | 0-10% |
| sodium bicarbonate | Balance |

The acidic cleaning composition can be in liquid form, such as the cleaning compositions disclosed in EP 1 196 033, or in granular form such as the cleaning compositions disclosed in WO2006/021861. For the cleaning of filtration media in water treatment installations, use of the granular acidic composition is preferred.
The composition includes in combination a cleaning solution portion (90-99.9% by volume) and a disinfectant portion (0.1-10% by volume). The composition is applied to any surface which has deposits formed thereon.

The disinfectant is a standard disinfectant, such as but not limited to hydrogen peroxide or peracidic acid.

Corrosion inhibitors used for inclusion in the cleaning composition in accordance with the invention can be selected from the group of nitrogen containing organic compounds, such as amines, quaternary ammonium compounds, heterocyclic nitrogen compounds, urea, thiourea, amide, or mixtures thereof. The most preferred inhibitors are Inhibitor 60S, commercially available from Thoma, Inc. and Rodine 102, from Parker Amchem.

The preferred embodiment of the present invention is directed toward the cleaning of surfaces specifically for the removal of deposits which have formed thereon and providing a disinfectant in combination.

With respect to the cleaning solution portion, exemplary basic formulations are:

### Example I

| Ingredients | Weight Percentage (Preferred) |
|---|---|
| Sulfamic | 0-20% (2.0%) |
| Citric Acid | 0-10% (10.0%) |
| Glycolic Acid | 0-15% (14.6%) |
| Phosphoric Acid | 0-13% (12.9%) |
| Hydrochloric Acid | 0-10% (10.0%) |
| Dyes | 0-0.01% (0.009%) |
| Water | Balance |

### Example II

| | Weight Percentage |
|---|---|
| Ingredients | (Range/Preferred) |
| Hydrochloric Acid | 0-20%/9.0% |
| Citric Acid | 0-1.5%/0.4% |
| Glycolic Acid | 0-15%/14.6% |
| Phosphoric Acid | 0-4%/2.0% |
| Triethylene glycol | 0-1.0%/0.50% |
| Water | Balance |

### Example III

| | Weight Percentage |
|---|---|
| Ingredients | (Range) |
| Sulfamic Acid | 0-20% |
| Hydrochloric Acid | 0-20% |
| Phosphoric Acid | 0-20% |
| Inhibitor | 0-1% |
| Isopropanol | 0-1% |
| Water | Balance |

### Example IV

| Ingredients | Weight Percentage (Range) |
|---|---|
| Phosphoric Acid | 5.0-20.0% |
| Inhibitor | 0-1.0% |
| Isopropanol | 0-1.0% |
| Water | Balance |

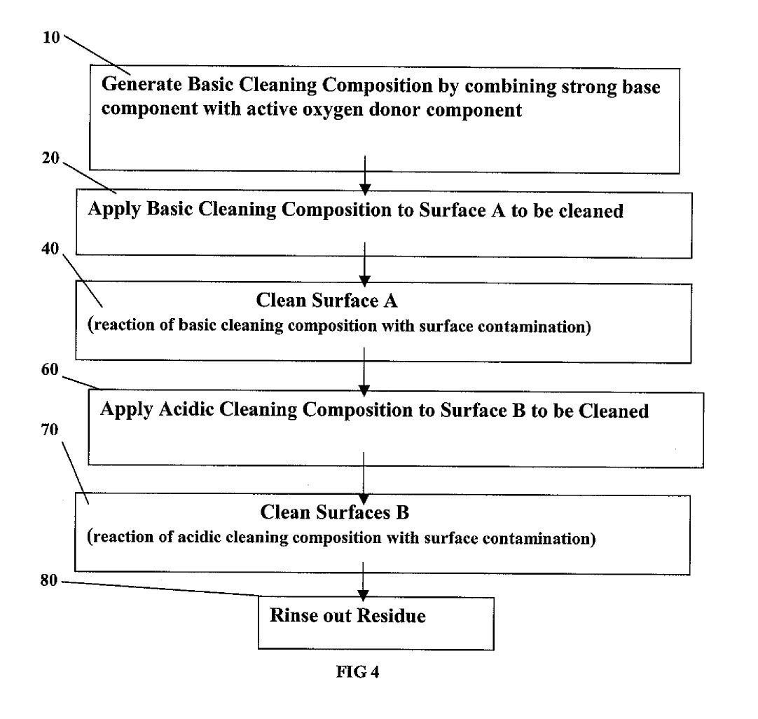

In a preferred embodiment of the combination treatment process, the basic cleaning composition and the acidic cleaning composition are applied successively or simultaneously to a contaminated surface. However, in yet another preferred embodiment of the combination treatment process, the basic and acidic cleaning compositions are applied to different portions of a structure or installation to be cleaned. This method is described in FIG. 4. This is especially useful for the cleaning of surfaces, which are in close proximity to or in contact with other surfaces that are susceptible to damage by either the acidic cleaning composition or the basic cleaning composition. In such situations, the susceptible surface, to be protected from the potentially damaging cleaning composition, is covered by or overlaid with the other cleaning composition (protective composition) to produce a protective layer on the susceptible surface. As will be readily understood, protection of the susceptible surface is achieved by neutralization of the potentially damaging composition by the protective composition at the susceptible surface. One particular example in which such embodiment of the present invention can be advantageously applied is in drinking water filtration or storage installations. For example, since biological fouling is usually a bigger problem with container walls, water nozzles and conduits rather than water filtration media, the acidic cleaning composition can be applied to the top of the filtration bed and the basic cleaning composition along the filter walls (especially untreated concrete walls) and above the water plenum and nozzles usually found below the filtration bed. Application of the basic cleaning composition can be achieved by way of pipes or lancets inserted along the walls and/or into the media to the desired location and level at which neutralization is to occur. Of course, applications in which the acidic cleaning composition is used to protect a susceptible surface from the effects of the basic cleaning composition are also conceivable. In other applications wherein a surface to be cleaned is located adjacent a susceptible surface, the protective composition is preferably applied before or simultaneous with application of the potentially damaging cleaning composition. Although the protective composition is advantageously also a cleaning composition in order to avoid attachment to the susceptible surface of the contaminants removed from the surface being cleaned. Simple protecting compositions without intended cleaning activity can also be used. Exemplary simple protecting compositions include inhibitors, or other compounds or compositions which are suitable to create a chemical and/or physical barrier between the potentially damaging composition and the susceptible surface. The barrier could be applied by spraying, brushing or rolling it directly onto the susceptible surface, or could be injected next to the susceptible surface in applications in which the susceptible surface is submerged. The protecting composition can be, for example, a metal hydroxide, such as sodium hydroxide, or potassium hydroxide, a common base, or a basic cleaning composition. The protective composition preferably includes a dye to assist with and facilitate application and visible detection.

Particularly preferred protecting compositions further include agents, which increase their attachment to the susceptible surface or to increase their residence time on the surface to reduce runoff. To improve adhesion and residence time of the protecting composition, it can be admixed with viscosity altering components to help control premature release of the protecting composition from the susceptible surface. For the same purpose, the protecting composition can be in the form of an emulsified oil composition, or even a water-soluble wax composition. In a particularly simple and effective embodiment, the protective composition itself is an emulsified oil or a water soluble wax composition.

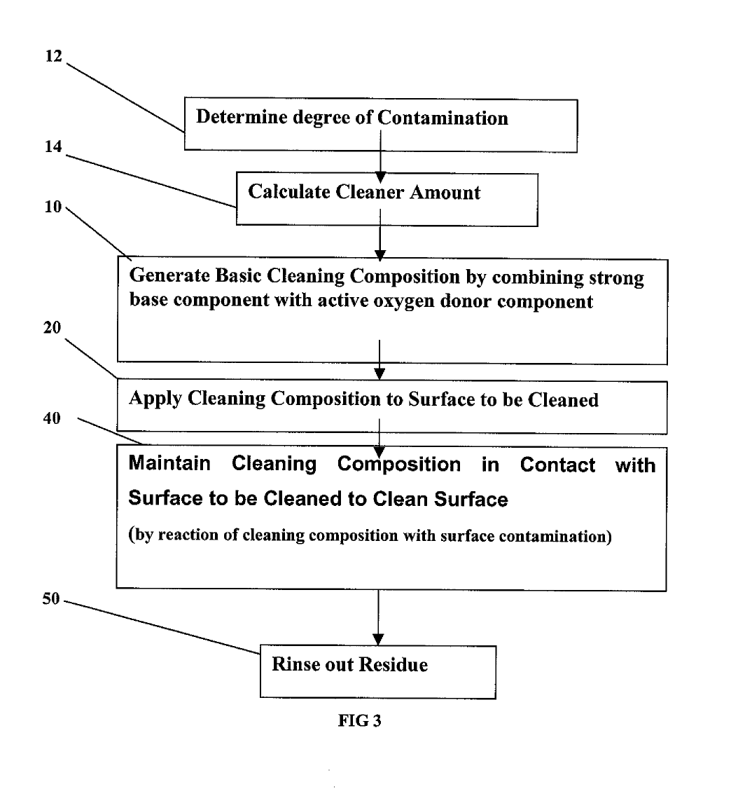

A further preferred embodiment of the process of the invention as illustrated in FIG. 3 includes a contamination analysis with an analysis step 10 for determining the degree of surface contamination on the surface to be cleaned and a calibration step 12 for calculating the amount and composition of the cleaning composition to be applied for ensuring maximum effectiveness of the cleaning process and to minimize the amount of unreacted cleaning composition remaining after the reaction step 40. The analysis step preferably includes the step of selecting a representative sample area, the sample having a known size. In the case of cleaning granular filter media, the sample can be collected and analyzed in the laboratory. The calibration step 12 preferably includes the steps of measuring the amount of cleaning composition required for substantially complete removal of the surface contaminants from the sample area and then extrapolating to the amount required for cleaning of the whole wetted surface to be cleaned. In the most preferred embodiment, the contamination analysis is used in connection with the combination cleaning process of FIG. 2 and includes an analysis step 10 and a calibration step 12 with respect to each of the cleaning compositions used. For example, where an acidic cleaning composition is used for the cleaning of granular filtration media and the basic cleaning composition is used for the cleaning and/or protection of the filter walls, the analysis step includes the step of taking a representative core sample of known volume from the filtration media. The core sample is preferably taken in an area of maximum or at least average contamination. Extrapolation to the amount required for cleaning of the whole filtration media bed is achieved by multiplying the measured amount of cleaning composition required for cleaning of the sample by the ratio of filtration bed volume/sample volume. The analysis step also includes the step of cleaning a representative filter wall area and extrapolating from the amount of cleaning composition used to the amount required to clean the whole filter wall. Preferably, the strength of the protective composition is adjusted to the strength of the cleaning composition to achieve full neutralization at the susceptible surface. Adjusting the amount of cleaning composition used to the respective contamination conditions provides the process of the invention with a significant economical advantage, since substantially no excess cleaner will be used, reducing the cost of the cleaning materials as well as the cost of disposing of any unreacted basic component and active oxygen donor.

While the invention has been described with a certain degree of particularity, it is understood that the invention is not limited to the embodiments set forth herein for purposes of exemplification, but is to be limited only by the scope of the attached claims, including the full range of equivalency to which each element thereof is entitled.

The above-described embodiments of the present invention are intended to be examples only. Alterations, modifications and variations may be effected to the particular embodiments by those of skill in the art without departing from the scope of the invention, which is defined solely by the claims appended hereto.

1. An acidic composition for removing deposits from wetted surfaces, consisting of
a cleaning solution portion; and
a disinfectant solution portion, said disinfectant portion being selected from the group consisting of peracetic acid and hydrogen peroxide,
wherein the cleaning solution portion includes sulfamic acid 2-20%, phosphoric acid 2-20% and an acid component selected from the group of, citric acid, glycolic acid, hydrochloric acid, and combinations thereof; and optionally including in said cleaning solution portion inhibitors, dyes, triethylene glycol, isopropanol and water.

2. A method for removing biological fouling from wetted surfaces, comprising of the steps of:
a. Preparing a cleaning composition by mixing of a basic component and an active oxygen donor component;
b. Applying the cleaning composition to a surface to be cleaned;
c. Allowing the composition to react; and
d. Removing any residual, unreacted cleaning composition and any removed biological fouling.

3. The method as described in claim 2, wherein the cleaning composition is applied by soaking the surface to be cleaned in the cleaning composition.

4. The method as described in claim 2, further including the step of applying an acidic cleaning composition to the surface to be cleaned after step c and prior to step d.

5. The method as described in claim 4, wherein the step of applying the acidic cleaning composition includes the steps of preparing a cleaning composition by mixing of an acidic component and an active oxygen donor component, applying the acidic cleaning composition to the surface to be cleaned and allowing the acidic cleaning composition to react.

6. The method as described in claim 4, wherein the step of applying the acidic cleaning composition is carried out by applying the composition in granular or liquid form across the surface and then applying the active oxygen donor component in a successive step.

7. The method as defined in claim 1, wherein the cleaning composition is applied by low-pressure spraying.

8. The method as defined in claim 1, wherein the residual cleaning composition and the removed biological fouling are removed by high-pressure water washing.

9. The method as defined in claim 1, wherein the wetted surface to be cleaned is the granular fill of a filter bed and the residual cleaning composition and the removed biological fouling are removed by initiating backwash of the filter bed.

10. The method as defined in claim 1, wherein the surface to be cleaned is a water line and the residual cleaning composition and the removed biological fouling are removed by flushing the water line.

11. The method as defined in claim 1, wherein the surface to be cleaned is in a water treatment, water storage or water conducting facility.

12. The method as defined in claim 1, wherein the surface to be cleaned is a boat hull, a cooling tower or a swimming pool.

13. The method as defined in claim 1, wherein the biological growth to be removed includes hydozoa, bryozoa, sponges, mollusks, algae or microbial films.

14. The method as defined in claim 10, wherein the biological growth to be removed includes algae and microbial films.

15. The method as defined in claim 1, comprising the additional step of applying an acidic cleaning composition to the treatment surface for removal of mineral deposits on the treatment surface before or after the rinsing step, the acidic cleaning composition including at least two components, an acidic component and an active oxygen donor.

16. The method as defined in claim 12, wherein the amounts of basic cleaning composition and acidic cleaning composition are selected such that cleaning residue accumulated after application of both compositions is substantially pH neutral.

17. The method as defined in claim 12, wherein the acidic cleaning composition is applied either before or after the step of removing any residual, unreacted basic cleaning composition and any removed biological fouling.

18. A cleaning composition for removal of biological fouling from wetted surfaces, comprising at least two components, a strong base component and an active oxygen donor component, which are shipped and stored separately and mixed upon application.

19. The cleaning composition as defined in claim 12, wherein the strong base component is 0.5M to 10M sodium hydroxide and the active oxygen donor component is 0.1% to 10% hydrogen peroxide.

20. The cleaning composition as defined in claim 12, wherein the strong base component is 0.5M to 11.4M potassium hydroxide and the active oxygen donor component is 0.1% to 20% hydrogen peroxide.

21. The cleaning composition as defined in claim 12, wherein the strong base component contains a blend of sodium hydroxide and potassium hydroxide.

22. A cleaning composition for removal of biological deposits from wetted surfaces, prepared by mixing a concentrated stock solution of a strong base component with an active oxygen donor component and water in a mixing container at a site of application of the composition.

23. The cleaning composition as defined in claim 16, wherein the active oxygen donor component is peracetic acid or a combination of peracetic acid and hydrogen peroxide.

24. The cleaning composition as defined in claim 16, wherein the active oxygen donor component is supplied in the form of a granular precursor of hydrogen peroxide, such as sodium percarbonate, or a granular precursor of peracetic acid, or combinations thereof.

25. The cleaning composition as defined in claim 16, further comprising 0.2-2.0% (w/w) of a non-ionic, cationic, anionic, low foam or no foam surfactant.

26. The cleaning composition as defined in claim 16, further comprising 0.25-2.0% (w/w) of a de-foaming agent.
